(19) United States
(12) Patent Application Publication
(10) Pub. No.: US 2026/0077337 A1
(43) Pub. Date: Mar. 19, 2026

(54) Photocatalyst

(71) Applicant: SEIKO EPSON CORPORATION, Tokyo (JP)

(72) Inventors: Honghao HOU, Fujimi (JP); Ryoji KOMATSU, Ina (JP); Ichiro ASAOKA, Fujimi (JP); Toshiki HARA, Suwa (JP); Yukiko II, Suwa (JP); Yasuto KAKEMURA, Kai (JP)

(21) Appl. No.: 19/332,562

(22) Filed: Sep. 18, 2025

(30) Foreign Application Priority Data
Sep. 19, 2024 (JP) 2024-162041

(51) Int. Cl. B01J 21/06; B01J 23/652; B01J 35/39; B01J 35/40; B01J 35/70

(52) U.S. Cl. CPC B01J 21/063; B01J 23/6522; B01J 35/39; B01J 35/40; B01J 35/733

(57) ABSTRACT

A photocatalyst has a perovskite type crystal, the photocatalyst has, present on a surface, a stepped structure including a terrace and a step, and an occupancy ratio of a projected area of the stepped structure to a total projected area in an observation image of the surface is 20% or more. It is preferable that the terrace is formed of a {100} facet, and the step is formed of the {100} facet or a {110} facet.

The present application is based on, and claims priority from JP Application Serial Number 2024-162041, filed Sep. 19, 2024, the disclosure of which is hereby incorporated by reference herein in its entirety.

### BACKGROUND

### 1. Technical Field

The present disclosure relates to a photocatalyst.

### 2. Related Art

A particulate photocatalyst is disclosed in Takata, Tsuyoshi, et al., “Photocatalytic water splitting with a quantum efficiency of almost unity”, Nature 581.7809, 2020, p. 411-414, which uses aluminum-doped strontium titanate and enables water splitting with a maximum external quantum efficiency of 96% under light having a wavelength of 350 to 360 nm. It is also disclosed that an evolution reaction of hydrogen and oxygen can be promoted separately on different crystal facets of the photocatalyst by selectively performing photo-assisted electrodeposition of a co-catalyst to the photocatalyst.

Takata, Tsuyoshi, et al., “Photocatalytic water splitting with a quantum efficiency of almost unity”, Nature 581.7809, 2020, p. 411-414 is an example of the related art.

The photocatalyst having a perovskite type crystal in the related art has a high quantum efficiency immediately after preparation, but there is a problem in that catalytic activity decreases due to long-time light irradiation. Therefore, there is a demand for a highly stable photocatalyst that can maintain high activity for a long time.

### SUMMARY

A photocatalyst according to an application example of the disclosure is
a photocatalyst having:
a perovskite type crystal, in which
the photocatalyst has, present on a surface, a stepped structure including a terrace and a step, and
an occupancy ratio of a projected area of the stepped structure to a total projected area in an observation image of the surface is 20% or more.

### BRIEF DESCRIPTION OF THE DRAWINGS

FIG. 1 is a schematic view showing a photocatalyst according to an embodiment.

FIG. 2 is a plan view schematically showing a terrace and a step constituting a stepped structure in a plan view of a main surface shown in FIG. 1.

FIG. 3 is a cross-sectional view taken along a line A-A in FIG. 2.

FIG. 4 is a cross-sectional view taken along a line B-B in FIG. 2.

FIG. 5 is a partially enlarged view of FIG. 3 and is a schematic view showing a function of the stepped structure.

FIG. 6 shows an electron microscope observation image (A) of the photocatalyst according to the embodiment, and a view (B) in which a marker specifying the stepped structure is overlaid on the observation image.

FIG. 7 shows an electron microscope observation image (A′) of a photocatalyst according to Comparative Example and a view (B′) in which a marker specifying a stepped structure is overlaid on the observation image.

FIG. 8 is a cross-sectional view showing a support of the photocatalyst according to the embodiment and a co-catalyst loaded at a surface of the support.

FIG. 9 is Table 1 showing production conditions of a photocatalyst of each of Examples and Comparative Example and an evaluation result of the produced photocatalyst.

FIG. 10 shows, for a photocatalyst obtained in Example 1, an observation image of a support before loading a co-catalyst and a schematic view thereof, an observation image of a Pt-loaded support after a Pt loading test is performed on the support shown in the observation image and a schematic view thereof, and an observation image of a CoOy-loaded support after a CoOy loading test is performed on the support shown in the observation image and a schematic view thereof.

FIG. 11 shows, for a photocatalyst obtained in Comparative Example, an observation image of a support before loading a co-catalyst and a schematic view thereof, an observation image of a Pt-loaded support after a Pt loading test is performed on the support shown in the observation image and a schematic view thereof, and an observation image of a CoOy-loaded support after a CoOy loading test is performed on the support shown in the observation image and a schematic view thereof.

FIG. 12 is a graph comparing changes in gas evolution rates over 11 days for the photocatalyst obtained in Example 1 and the photocatalyst obtained in Comparative Example.

### DESCRIPTION OF EMBODIMENTS

Hereinafter, a photocatalyst according to the disclosure will be described in detail based on an embodiment shown in the accompanying drawings.

### 1. Photocatalyst

### 1.1. Overview of Photocatalyst

First, an overview of a photocatalyst according to the embodiment will be described.

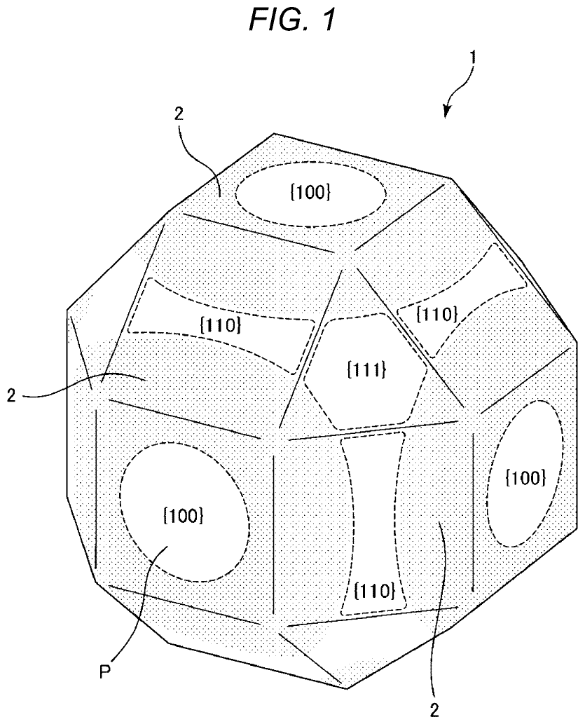

FIG. 1 is a schematic view showing a photocatalyst 1 according to the embodiment. The photocatalyst 1 shown in FIG. 1 is particulate and has a crystal of a perovskite type crystal. The photocatalyst 1 shown in FIG. 1 is usually used in a powder state in which a plurality of photocatalysts 1 are aggregated, and FIG. 1 shows one thereof. An outer shape of the photocatalyst 1 shown in FIG. 1 is one of typical shapes. Therefore, the outer shape of the photocatalyst 1 is not limited to the shape shown in FIG. 1.

The photocatalyst 1 is used as a catalyst for a water splitting reaction under light irradiation. Therefore, for example, by applying sunlight to the photocatalyst 1 in contact with water, hydrogen can be produced as renewable energy at a low cost.

The outer shape of the photocatalyst 1 shown in FIG. 1 is particulate, but is not limited thereto. For example, the shape may be fibrous, needle-like, flaky, substrate-like, or massive. Meanwhile, the photocatalyst 1 that is particulate has appropriate fluidity and can ensure a large specific surface area. Accordingly, it is possible to obtain the photocatalyst 1 that is easy to handle and has a high catalyst efficiency.

Examples of a crystal structure of the perovskite type crystal include a cubic crystal, a tetragonal crystal, an orthorhombic crystal, and a monoclinic crystal. Among these, a cubic perovskite type crystal is preferably used in the photocatalyst 1. The cubic perovskite type crystal contains, for example, a composite oxide represented by a general formula ABO₃ or ABO₂N. Here, A is at least one element selected from the group including strontium (Sr), sodium (Na), potassium (K), and barium (Ba). Here, B is at least one element selected from the group including titanium (Ti) and tantalum (Ta).

The photocatalyst 1 shown in FIG. 1 has a stepped structure 2 present on a surface. The stepped structure 2 is also called a terrace-step structure, and is a structure including a terrace, which is a flat surface, and a step, which intersects with the terrace and forms a height difference.

As a result of studies by the disclosers of the present application, it has been found that the presence of such a stepped structure 2 on the surface at a predetermined area ratio can construct a highly active catalytic reaction site for a water splitting reaction in the photocatalyst 1 and improve stability as a catalyst. That is, in the photocatalyst 1 having the stepped structure 2 on the surface at the predetermined area ratio, catalytic activity is unlikely to decrease even under long-time light irradiation, and high activity can be maintained for a long time. Hereinafter, a configuration of the photocatalyst 1 according to the embodiment will be described in detail.

### 1.2. Composition

A composition of the photocatalyst 1 is a substance constituting the perovskite type crystal.

Specific examples of the composite oxide include strontium titanate (SrTiO₃), sodium tantalate (NaTaO₃), and potassium tantalate (KTaO₃). Among these, strontium titanate (SrTiO₃) is preferably used. Strontium titanate has a high quantum efficiency for the water splitting reaction and is preferably used as a base catalyst material of the photocatalyst 1.

A metal element may also be added to the composite oxide. Accordingly, an electronic state of the composite oxide can be controlled, and a wavelength of light to which the photocatalyst 1 responds can be adjusted, and the quantum efficiency can be improved. Examples of the metal element doped into the composite oxide include aluminum (Al), sodium (Na), magnesium (Mg), gallium (Ga), indium (In), lanthanum (La), rhodium (Rh), iridium (Ir), chromium (Cr), and ruthenium (Ru), and one or two or more of these are used.

An amount of metal ions added is not particularly limited, and is preferably 0.05 atomic % or more and 10 atomic % or less of the total composite oxide, more preferably 0.1 atomic % or more and 5 atomic % or less, and still more preferably 0.3 atomic % or more and 3 atomic % or less. Accordingly, the catalytic activity of the photocatalyst 1 can be further improved.

### 1.3. Crystal Structure

The surface of the photocatalyst 1 shown in FIG. 1 is formed of an aggregate of several flat surfaces. The term “flat surface” in the present specification is not limited to a strictly flat surface, and may be a surface with slight irregularities, distortions, or the like. Normally, a crystal facet of the perovskite type crystal is exposed on such a flat surface.

FIG. 1 shows an example of a Miller index of the crystal facet exposed on the surface of the photocatalyst 1. In the example shown in FIG. 1, the flat surface contained in the surface of the photocatalyst 1 is any one of a {100} facet, a {110} facet, or a {111} facet.

When the surface of the photocatalyst 1 is observed with an electron microscope, a flat surface having a largest projected area in an obtained observation image is referred to as a “main surface P”, The electron microscope is a scanning electron microscope (SEM), a transmission electron microscope (TEM), or a scanning transmission electron microscope (STEM).

In the example shown in FIG. 1, a plurality of facets are exposed on the surface of the photocatalyst 1, and one thereof is the main surface P. The main surface of the photocatalyst may be the {110} facet. That is, the main surface of the photocatalyst is preferably the {100} facet or the {110} facet. Such crystal facets are active surfaces having high catalytic activity. Therefore, the photocatalyst having such crystal facets as main surfaces has high catalytic activity.

The perovskite type crystal is a base catalyst of the photocatalyst 1. Inside the perovskite type crystal, a phenomenon occurs in which electrons and holes excited by light move in directions different from each other. Due to such a phenomenon, a site that donates electrons to water to evolve hydrogen and a site that donates holes to water to evolve oxygen are formed at the surface of the photocatalyst 1. The perovskite type crystal also functions as a support for loading a co-catalyst to be described later.

### 1.4. Stepped Structure

The stepped structure 2 is specified from a state in which, when the photocatalyst 1 is observed with the electron microscope, terraces and steps having a brightness difference from each other extend in an elongated strip shape in an observation image. In FIG. 1, regions occupied by the stepped structure 2 in the observation image are indicated by dots.

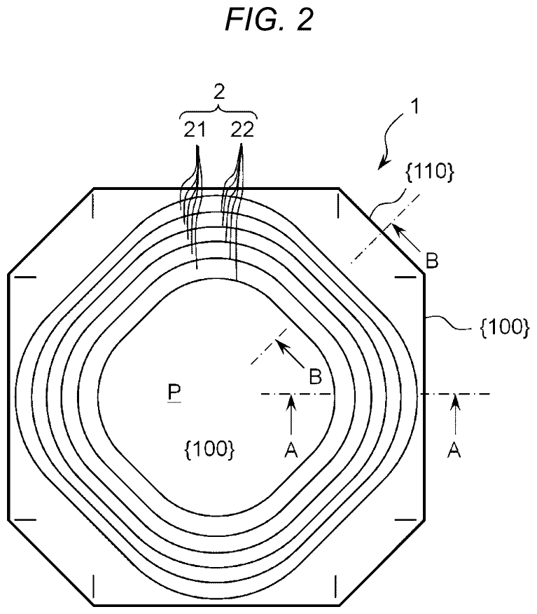

FIG. 2 is a plan view schematically showing a terrace 21 and a step 22 constituting the stepped structure 2 in a plan view of the main surface P shown in FIG. 1.

As shown in FIG. 2, the stepped structure 2 includes the terrace 21 that is a surface parallel to the main surface P (flat surface) and the step 22 that is a surface intersecting the terrace 21. The terrace 21 and the step 22 extend elongatedly in substantially the same direction.

An arrangement of the stepped structure 2 on the surface of the photocatalyst 1 is not particularly limited, and as shown in FIG. 1, the stepped structure 2 is distributed to surround at least one flat surface contained in the surface of the photocatalyst 1. Accordingly, the stepped structure 2 serving as a highly active catalytic reaction site can be uniformly distributed evenly on the surface of the photocatalyst 1. As a result, the photocatalyst 1 having a high catalyst efficiency can be obtained.

The stepped structure 2 is preferably distributed to surround the {100} facet or the {110} facet. The {100} facet and the {110} facet are active surfaces. Therefore, since the stepped structure 2 is distributed to surround the active surface, the photocatalyst 1 having a particularly high catalyst efficiency can be obtained. In FIGS. 1 and 2, as an example, the stepped structure 2 is distributed to surround the {100} facet.

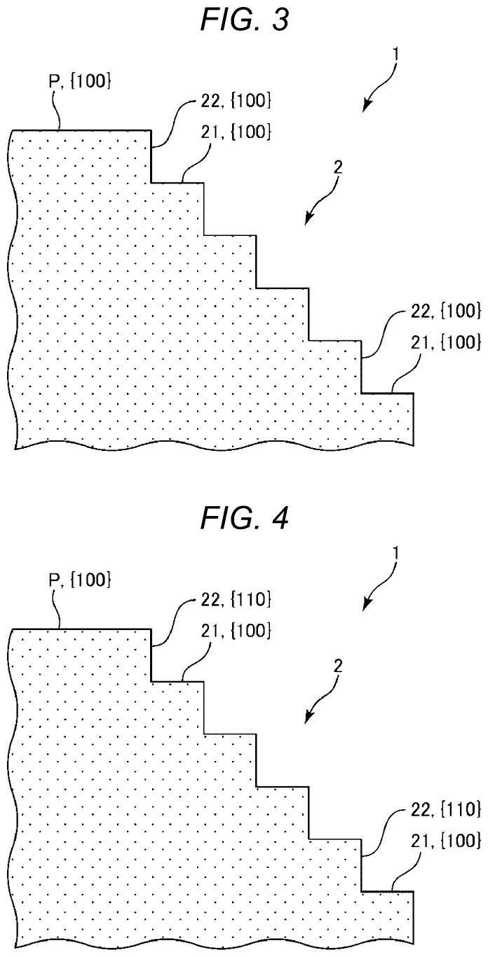

FIG. 3 is a cross-sectional view taken along a line A-A in FIG. 2. The line A-A in FIG. 2 is a straight line drawn to connect a flat surface (main surface P) that is the facet to another {100} facet that is adjacent to the flat surface via another crystal facet.

As shown in FIG. 3, when the photocatalyst 1 is cut along a plane including the A-A line, a periodic structure in which the terrace 21 and the step 22 are alternately arranged appears on a cut surface thereof. In this case, a surface that drops from an end of the main surface P shown in FIG. 3 is defined as the “step 22”. In the periodic structure shown in FIG. 3, with this step 22 serving as a starting point, the terrace 21 and the step 22 are alternately arranged in a direction away from the main surface P. The terrace 21 and the step 22 shown in FIG. 3 are all {100} facets.

FIG. 4 is a cross-sectional view taken along a line B-B in FIG. 2. The line B-B in FIG. 2 is a straight line drawn to connect a flat surface (main surface P) that is the facet to the {110} facet that is adjacent to the flat surface via another crystal facet.

As shown in FIG. 4, when the photocatalyst 1 is cut along a plane including the B-B line, a periodic structure in which the terrace 21 and the step 22 are alternately arranged appears on a cut surface thereof. In this case, a surface that drops from an end of the main surface P shown in FIG. 4 is defined as the “step 22”. In the periodic structure shown in FIG. 4, with this step 22 serving as a starting point, the terrace 21 and the step 22 are alternately arranged in a direction away from the main surface P. Each terrace 21 shown in FIG. 4 is the {100} facet, and each step 22 shown in FIG. 4 is the {110} facet.

As described above, the stepped structure 2 is a unique structure in which crystal facets having the same Miller index or crystal facets having different Miller indices are adjacent to each other in a narrow range. As described above, the stepped structure 2 functions as a highly active catalytic reaction site for the water splitting reaction.

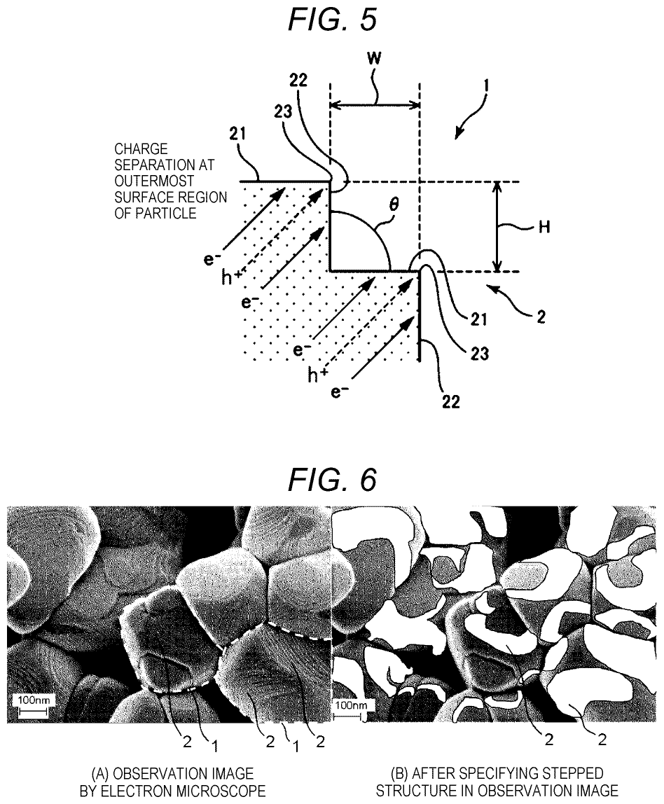

FIG. 5 is a partially enlarged view of FIG. 3 and is a schematic view showing a function of the stepped structure 2.

As shown in FIG. 5, the stepped structure 2 includes a ridge portion 23. The ridge portion 23 is a portion in the vicinity of an edge located at a boundary between the terrace 21 and the step 22. The ridge portion 23 forms a site different from the terrace 21 and the step 22.

Specifically, in the perovskite type crystal, electrons e⁻ excited by light selectively move to the terrace 21 or the step 22 at a short distance (in the vicinity of an excitation site). Accordingly, the terrace 21 and the step 22 serve as electrons e⁻ separation sites and serve as hydrogen evolution sites for evolving hydrogen from water. Meanwhile, holes h⁺ excited by light selectively move to the ridge portion 23 at a short distance. Accordingly, the ridge portion 23 serves as a hole h⁺ separation site and serves as an oxygen evolution site for evolving oxygen from water.

In this way, in the stepped structure 2, a region where the electrons e⁻ move and separate and a region where the holes h⁺ move and separate are close to a narrow range. Accordingly, each movement distance when the excited electrons e⁻ and holes h⁺ move in the photocatalyst 1 can be shortened. Accordingly, probability of recombination between the electrons e⁻ and the holes h⁺ decreases, and a decrease in photocatalytic activity can be prevented.

As a result of studies by the disclosers of the present application, it has been found that the presence of such a stepped structure 2 on the surface at the predetermined area ratio is important. Specifically, in the photocatalyst 1 according to the embodiment, in the observation image of the surface thereof, an occupancy ratio of a projected area of the stepped structure 2 to a total projected area is 20% or more. That is, when a total projected area of particles of the photocatalyst 1 shown in the observation image is 100%, the ratio of the projected area of the stepped structure 2 is 20% or more. Since the stepped structure 2 is provided at such a ratio, the recombination between the electrons e⁻ and the holes h⁺ in the photocatalyst 1 is significantly reduced. Accordingly, it is possible to obtain the highly stable photocatalyst 1 whose high activity can be maintained for a long time.

Since the terrace 21 and the step 22 are surfaces facing a recessed space, the terrace 21 and the step 22 are unlikely to receive an external force. Therefore, for example, when the co-catalyst is loaded at such a surface, detachment of the co-catalyst due to an external force can be prevented. Therefore, by providing the stepped structure 2 at the predetermined area ratio, high activity can be maintained for a long time.

FIG. 6 shows an electron microscope observation image (A) of the photocatalyst 1 according to the embodiment, and a view (B) in which a marker specifying the stepped structure 2 is overlaid on the observation image.

In the observation image (A) shown in FIG. 6, for example, two particles of the photocatalyst 1 are surrounded by broken lines. In the two particles, an area of a portion surrounded by such broken lines corresponds to the “total projected area”. In the observation image (A), the stepped structure 2 distributed over a wide range can be seen. In (B) in FIG. 6, a range occupied by the stepped structure 2 is filled with a white marker. An area of the white marker corresponds to the “projected area of the stepped structure 2”. When the “occupancy ratio of the projected area of the stepped structure 2” is calculated, a ratio of the projected area of the stepped structure 2 to the total projected area is calculated for five or more photocatalysts 1 shown in the one observation image (A), and an average value is calculated. This average value is taken as the “occupancy ratio of the projected area of the stepped structure 2”.

The occupancy ratio of the stepped structure 2 is 20% or more, preferably 25% or more, and more preferably 30% or more. When the occupancy ratio of the stepped structure 2 is less than the lower limit value, an effect of reducing the recombination between the electrons e⁻ and the holes h⁺ is limited, and thus stability of the photocatalyst 1 decreases.

Meanwhile, an upper limit value of the occupancy ratio of the stepped structure 2 may not be particularly set, and is preferably 90% or less, more preferably 80% or less, and further preferably 70% or less in consideration of an increase in production difficulty.

The observation image (A) may be an image having an imaging range in which five or more photocatalysts 1 are simultaneously shown. The five or more photocatalysts 1 may be randomly extracted, and are preferably selected in descending order of projected area. Photocatalysts 1 overlapping with each other may be selected, or a photocatalyst 1 having a part missing at an end of the observation image (A) may be selected.

One side of an imaging range of the observation image (A) is preferably 500 nm or more, and more preferably 800 nm or more and 2,000 nm or less.

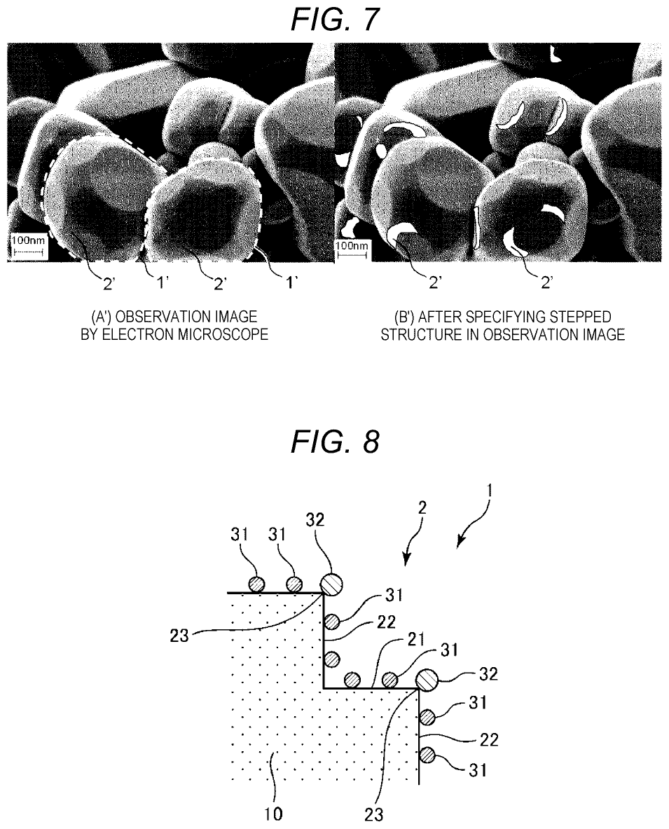

FIG. 7 is an electron microscope observation image (A′) of a photocatalyst 1′according to Comparative Example and a view (B′) in which a marker specifying a stepped structure 2′ is overlaid on the observation image.

In the observation image (A′) shown in FIG. 7, for example, two particles of the photocatalyst 1′ are surrounded by broken lines. In (B′) in FIG. 7, a range occupied by the stepped structure 2′ is filled with a white marker. A method for calculating an “occupancy ratio of a projected area of the stepped structure 2′” in the photocatalyst 1′ according to Comparative Example is the same as that in the case of the photocatalyst 1 according to the embodiment.

In the photocatalyst 1′ shown in FIG. 7, the occupancy ratio of the projected area of the stepped structure 2′ is small and less than 20%. In this case, in the photocatalyst 1′, reduction in the recombination between the electrons e⁻ and the holes h⁺ is insufficient and high activity cannot be maintained for a long time.

A width W shown in FIG. 5 is a width of the terrace 21. The width W of the terrace 21 is not particularly limited, and is preferably 3 nm or more and 25 nm or less, more preferably 4 nm or more and 20 nm or less, and further preferably 5 nm or more and 15 nm or less. If the width W of the terrace 21 is within the above range, a repetition period of the terrace 21, the step 22, and the ridge portion 23 can be optimized. Accordingly, it is possible to obtain the photocatalyst 1 having particularly high catalytic activity and a higher density of hydrogen evolution sites and oxygen evolution sites.

When the width W is less than the lower limit value, difficulty in forming the terrace 21 may increase or an effective area of the hydrogen evolution site may decrease. On the other hand, when the width W exceeds the upper limit value, the difficulty in forming the terrace 21 may increase, or the long-term catalytic activity may be difficult to maintain.

A height H shown in FIG. 5 is a height of the step 22. The height H of the step 22 is not particularly limited, and is preferably 3 nm or more and 25 nm or less. If the height H of the step 22 is within the above range, the repetition period of the terrace 21, the step 22, and the ridge portion 23 can be optimized. Accordingly, it is possible to obtain the photocatalyst 1 having particularly high catalytic activity and a higher density of hydrogen evolution sites and oxygen evolution sites.

When the height H is less than the lower limit value, difficulty in forming the step 22 may increase or the effective area of the hydrogen evolution site may decrease. On the other hand, when the height H exceeds the upper limit value, the difficulty in forming the step 22 may increase or the long-term catalytic activity may be difficult to maintain.

Examples of a method for measuring the width W of the terrace 21 and the height H of the step 22 include a method of measuring on an observation image of a transmission electron microscope (TEM) or a scanning transmission electron microscope (STEM). In this case, the photocatalyst 1 may be sliced to prepare a thin sample, and the observation image may be acquired from the thin sample.

The stepped structure 2 is preferably a structure in which the terrace 21 and the step 22 are alternately repeated a plurality of times. In such a structure, the hydrogen evolution sites and the oxygen evolution sites close to each other at a high density can be distributed more widely. Accordingly, it is possible to obtain the photocatalyst 1 having high stability and a high catalyst efficiency.

The number of repetitions of the terrace 21 and the step 22 in the independent stepped structure 2 is not particularly limited, and is preferably 5 or more, and more preferably 10 or more. Accordingly, the photocatalyst 1 having particularly high stability and catalyst efficiency is obtained. The upper limit value of the number of repetitions may not be particularly set, and is preferably 50 or less in consideration of an increase in production difficulty. The independent stepped structure 2 refers to, for example, one that is disposed to surround the {100} facet in FIG. 1 and is separated from another stepped structure 2 via a flat surface such as the {110} facet or the {111} facet.

A dihedral angle θ shown in FIG. 5 is an angle of a dihedral angle formed between the terrace 21 and the step 22 on a space side. The dihedral angle θ is preferably 90° or more, and more preferably 90° or more and 100° or less. According to such a configuration, it is possible to prevent an increase in difficulty in forming the stepped structure 2. In addition, when water comes into contact with the stepped structure 2, a contact efficiency with water can be improved. Further, detachment of the co-catalyst loaded at the terrace 21 and the step 22 can be prevented. When the dihedral angle θ is out of the above range, the difficulty in producing the stepped structure 2 may increase, the contact efficiency with water may decrease, an efficiency of the water splitting reaction may decrease, or the loaded co-catalyst may easily be detached. A method for measuring the dihedral angle θ is the same as each method for measuring the width W and the height H.

### 1.5. Photocatalyst Outer Shape

As described above, the outer shape of the photocatalyst 1 is preferably particulate. An average particle diameter of the particulate photocatalyst 1 is preferably 50 nm or more and 30,000 nm or less, more preferably 80 nm or more and 1,000 nm or less, and further preferably 100 nm or more and 500 nm or less. If the average particle diameter is within the above range, the photocatalyst 1 can be handled as fine particles (fine powder). That is, since the photocatalyst 1 is a fine powder, shape flexibility is high and there is a wide range of arrangement method options, and thus the photocatalyst 1 that can easily implement water splitting apparatuses having various structures is obtained.

The average particle diameter of the photocatalyst 1 is measured as follows.

First, the particulate photocatalyst 1 is observed with an electron microscope to obtain an observation image. Next, one photocatalyst 1 that does not overlap any other photocatalyst 1 in the observation image is selected. A diameter of a circumscribed circle of a projected image of the selected photocatalyst 1 is defined as a particle diameter. In this way, particle diameters of 10 or more photocatalysts 1 are obtained, and an average value thereof is taken as the “average particle diameter”.

An average aspect ratio (minor axis diameter/major axis diameter) of the particulate photocatalyst 1 is not particularly limited, and is preferably 0.5 or more and 1.0 or less, and more preferably 0.6 or more and 1.0 or less. If the average aspect ratio is within the above range, it is possible to obtain the photocatalyst 1 having relatively low production difficulty and excellent handleability.

The average aspect ratio of the photocatalyst 1 is measured as follows.

First, the particulate photocatalyst 1 is observed with an electron microscope to obtain an observation image. Next, one photocatalyst 1 that does not overlap any other photocatalyst 1 in the observation image is selected. A projected image of the selected photocatalyst 1 is interposed between two straight lines parallel to each other. A widest interval between the two straight lines is defined as the long axis diameter, and a narrowest interval therebetween is defined as the short axis diameter. In this way, aspect ratios of ten or more photocatalysts 1 are obtained, and an average value thereof is taken as the “average aspect ratio”.

### 1.6. Co-Catalyst

The photocatalyst 1 may include, in addition to the support (base catalyst) including the perovskite type crystal, the co-catalyst loaded at a surface of the support.

FIG. 8 is a cross-sectional view showing a support 10 of the photocatalyst 1 according to the embodiment and co-catalysts 31 and 32 loaded at a surface of the support 10.

The co-catalyst 31 is a hydrogen evolution co-catalyst, and is loaded at the hydrogen evolution site and has, for example, a function of improving a hydrogen evolution efficiency and extending a lifespan of the hydrogen evolution site. As shown in FIG. 8, the co-catalyst 31 is mainly loaded at the terrace 21 and the step 22 of the support 10. Since the terrace 21 and the step 22 are separated from each other via the ridge portion 23, a size of the loaded co-catalyst 31 is also controlled to a minute and uniform size. It is considered that the size of the co-catalyst 31 affects an electronic structure of the co-catalyst 31 and affects the function of the co-catalyst 31. Since the width W of the terrace 21 and the height H of the step 22 are controlled to about several nm to several tens of nm as described above, the size of the co-catalyst 31 is optimized to be equal to or less than the same. Accordingly, the hydrogen evolution efficiency can be further improved, and the lifespan of the hydrogen evolution site can be extended sufficiently. Although not shown in FIG. 8, the co-catalyst 31 may also be loaded at a flat surface of the support 10.

Examples of a material of the co-catalyst 31 include a material containing at least one selected from the group including rhodium (Rh), platinum (Pt), ruthenium (Ru), nickel (Ni), and gold (Au). The material of the co-catalyst 31 may also be a metal containing these metal elements, a metal oxide, or a metal hydroxide. Further, a composite oxide or a mixed oxide of these metal elements and other metal elements may be used. Examples of the composite oxide include a rhodium-chromium composite oxide (RhCrOx). Examples of the mixed oxide include a rhodium-chromium mixed oxide (RhCrOx).

The co-catalyst 32 is an oxygen evolution co-catalyst, and is loaded at the oxygen evolution site and has, for example, a function of improving an oxygen evolution efficiency and extending a lifespan of the oxygen evolution site. As shown in FIG. 8, the co-catalyst 32 is mainly loaded at the ridge portion 23 of the support 10. Since the ridge portion 23 is separated from another ridge portion 23 via the terrace 21 or the step 22, a size of the loaded co-catalyst 32 is also controlled to a minute and uniform size. It is considered that the size of the co-catalyst 32 affects an electronic structure of the co-catalyst 32 and affects the function of the co-catalyst 32. Since the width W of the terrace 21 and the height H of the step 22 are controlled to about several nm to several tens of nm as described above, a width of the ridge portion 23 is controlled to be narrower. Therefore, the size of the co-catalyst 32 is also optimized to be equal to or less than the width of the ridge portion 23. Accordingly, the oxygen evolution efficiency can be further improved, and the lifespan of the oxygen evolution site can be extended sufficiently.

Examples of a material of the co-catalyst 32 include a material containing at least one selected from the group including iridium (Ir), cobalt (Co), ruthenium (Ru), and iron (Fe). The material of the co-catalyst 32 may be a metal oxide or a metal hydroxide. Examples of the metal oxide include a cobalt oxide (CoOy).

When the stepped structure 2 is distributed to surround the flat surface, the co-catalysts 31 and 32 are also distributed to surround the flat surface. Accordingly, an efficiency of charge transfer in the photocatalyst 1 is improved, catalytic activity of the photocatalyst 1 is further improved, and high activity can be maintained for a longer time.

An average particle diameter of the co-catalysts 31 and 32 is preferably 0.1 nm or more and 50 nm or less, and more preferably 0.5 nm or more and 20 nm or less. The average particle diameter of the co-catalysts 31 and 32 is obtained by averaging ten or more particle diameters of the co-catalysts 31 and 32 obtained by transmission electron microscope observation (TEM) or a scanning transmission electron microscope (STEM).

A loading amount of the co-catalysts 31 and 32 is not particularly limited, and is preferably 0.0001 or more and 0.1 or less when mass of the support 10 is 1, and more preferably 0.001 or more and 0.05 or less.

By setting the average particle diameter and the loading amount of the co-catalysts 31 and 32 within the above ranges, it is possible to favorably disperse and load the co-catalysts 31 and 32 on the surface of the support 10 while reducing absorption of light by the co-catalysts 31 and 32 (which prevents the support 10 from being sufficiently irradiated with light). In addition, more hydrogen evolution sites and oxygen evolution sites can be formed.

The co-catalysts 31 and 32 may be provided as necessary, and one or both thereof may be omitted.

### 2. Method for Producing Photocatalyst

Next, an example of a method for producing the photocatalyst 1 will be described. Hereinafter, a method for producing a support and a method for loading a co-catalyst on the produced support will be described.

### 2.1. Method for Producing Support

The support 10 shown in FIG. 8 is a crystal of a perovskite type crystal. The support 10 is produced by, for example, a flux method. The flux method is production through four steps of (1) forming a melt or a solution, (2) melting or dissolving a crystal raw material in the melt or the solution, (3) precipitation and grain growth of a crystal in the melt or in the solution, and (4) separating the precipitated crystal from the solution or a flux forming the melt. In the following description, a method using the melt will be described as an example.

First, the flux and the crystal raw material are mixed. For example, in a synthesis of Al-doped SrTiO₃, commercially available SrTiO₃ and Al₂O₃ nanoparticles are placed in an automatic agate mortar, and are mixed and ground. Accordingly, a mixture of the flux and the crystal raw material is obtained. As the flux, a substance that does not react with the crystal raw material and is easily separated from the crystal raw material and the support 10 is preferably used. Examples of such a flux include halides, carbonates, sulfates, and low melting point oxides. In addition, by increasing a mixing time in the agate mortar, an occupancy ratio of the stepped structure formed in the crystal tends to increase.

Next, the obtained mixture is heated to form the melt. Next, the obtained melt is heated to react the crystal raw material in the melt. Accordingly, the crystal is precipitated in the melt, and the precipitated crystal is subjected to grain growth. A heating temperature is, for example, 800° C. or higher and 1,600°C. or lower. A holding time at this heating temperature is, for example, 30 minutes or longer. Examples of an atmosphere during heating include oxidizing atmospheres such as air and oxygen.

Next, the crystal is separated and collected by solid-liquid separation. For example, when the flux is water-soluble, the flux can be removed by washing with ion-exchanged water or pure water to separate the crystal. Accordingly, the support 10 is obtained.

### 2.2. Method for Loading Co-Catalyst

As shown in FIG. 8, the support 10 has the stepped structure 2. Hereinafter, a method of loading the co-catalysts 31 and 32 at the stepped structure 2 will be described.

Examples of the method for loading the co-catalysts 31 and 32 include a photo-assisted electrodeposition method, an impregnation method, and an adsorption-calcination method. Among these, the photo-assisted electrodeposition method is preferably used. In the photo-assisted electrodeposition method, the co-catalysts 31 and 32 can be selectively loaded at target positions. Hereinafter, the photo-assisted electrodeposition method will be described as an example.

First, the support 10 is suspended in distilled water to prepare a suspension. Next, a first precursor solution of the co-catalyst 31 is added to the suspension. When the material of the co-catalyst 31 is, for example, a rhodium-chromium composite oxide, examples of the first precursor solution include a RhCl₃ aqueous solution. Next, the suspension to which the first precursor solution is added is irradiated with light. A wavelength of the incident light is not particularly limited, and is preferably a wavelength to which the support 10 responds, more preferably 300 nm or more and 500 nm or less. An irradiation time of the light is appropriately adjusted depending on light intensity, and is, for example, 3 minutes or longer and 10 hours or shorter.

Next, after the irradiation with the light is stopped, a second precursor solution and a third precursor solution are added to the suspension. When the material of the co-catalyst 31 is, for example, the rhodium-chromium composite oxide, examples of the second precursor solution include a K₂CrO₄ aqueous solution. When the material of the co-catalyst 32 is, for example, a cobalt oxide, examples of the third precursor solution include a Co(NO₃)₂ aqueous solution. Next, the suspension to which the second precursor solution and the third precursor solution are added is irradiated with light. A wavelength of the incident light is not particularly limited, and is preferably a wavelength to which the support 10 responds, more preferably 300 nm or more and 500 nm or less. An irradiation time of the light is appropriately adjusted depending on light intensity, and is, for example, 3 minutes or longer and 10 hours or shorter.

Due to the irradiation with light as described above, the rhodium-chromium composite oxide is deposited on the terrace 21, the step 22, and the like of the support 10 by photo-assisted electrodeposition, and the co-catalyst 31 is loaded. In addition, the cobalt oxide is deposited on the ridge portion 23 and the like of the support 10 by photo-assisted electrodeposition, and the co-catalyst 32 is loaded.

As described above, the photocatalyst 1 is obtained.

### 3. Hydrogen Production Apparatus

The photocatalyst 1 is used in, for example, a hydrogen production apparatus. The hydrogen production apparatus includes a container having a transparent light incident surface for irradiating the photocatalyst 1 with light, a water supply device for supplying water to the container, a hydrogen separation unit for separating evolved hydrogen, and a hydrogen storage unit for storing the evolved hydrogen. The light with which the photocatalyst 1 is irradiated is preferably sunlight.

### 4. Effects of Embodiment

As described above, the photocatalyst 1 according to the embodiment is a photocatalyst having the perovskite type crystal, and has the stepped structure 2 including the terrace 21 and the step 22 present on the surface. In the observation image of the surface, the occupancy ratio of the projected area of the stepped structure 2 to the total projected area is 20% or more.

According to such a configuration, a highly stable photocatalyst 1 that can maintain high activity for a long time is obtained.

In the photocatalyst 1 according to the embodiment, it is preferable that the stepped structure 2 is a structure in which the terrace 21 and the step 22 are alternately repeated a plurality of times.

According to such a configuration, hydrogen evolution sites and oxygen evolution sites close to each other at a high density can be distributed more widely. Accordingly, it is possible to obtain the photocatalyst 1 having high stability and a high catalyst efficiency.

In the photocatalyst 1 according to the embodiment, the perovskite type crystal is preferably a cubic crystal. In addition, the surface of the photocatalyst 1 preferably has a flat surface formed of the {100} facet.

According to such a configuration, since the facet is an active surface, the stepped structure 2 is distributed to surround the active surface, and thus the photocatalyst 1 having a particularly high catalyst efficiency can be obtained.

In the photocatalyst 1 according to the embodiment, the terrace 21 may be formed of the {100} facet. In this case, the step 22 is preferably formed of the {100} facet or the {110} facet.

According to such a configuration, the stepped structure 2 is a unique structure in which crystal facets having the same Miller index or crystal facets having different Miller indices are adjacent to each other in a narrow range. Therefore, the stepped structure 2 functions as a highly active catalytic reaction site for the water splitting reaction.

In the photocatalyst 1 according to the embodiment, the dihedral angle θ between the terrace 21 and the step 22 is preferably 90° or more.

According to such a configuration, it is possible to prevent an increase in difficulty in forming the stepped structure 2. In addition, when water comes into contact with the stepped structure 2, a contact efficiency with water can be improved. Further, detachment of the co-catalyst loaded at the terrace 21 and the step 22 can be prevented.

In the photocatalyst 1 according to the embodiment, the stepped structure 2 may be distributed to surround the flat surface.

According to such a configuration, it is possible to obtain the photocatalyst 1 having a particularly high catalyst efficiency.

In the photocatalyst 1 according to the embodiment, the width W of the terrace 21 is preferably 3 nm or more and 25 nm or less.

According to such a configuration, the repetition period of the terrace 21, the step 22, and the ridge portion 23 can be optimized. Accordingly, it is possible to obtain the photocatalyst 1 having particularly high catalytic activity and a higher density of hydrogen evolution sites and oxygen evolution sites.

The photocatalyst 1 according to the embodiment preferably has an average particle diameter of 50 nm or more and 30,000 nm or less.

According to such a configuration, the photocatalyst 1 can be handled as fine particles (fine powder). That is, since the photocatalyst 1 is a fine powder, shape flexibility is high and there is a wide range of arrangement method options, and thus the photocatalyst 1 that can easily implement water splitting apparatuses having various structures is obtained.

The photocatalyst 1 according to the embodiment may include the co-catalysts 31 and 32 in contact with the stepped structure 2.

According to such a configuration, a hydrogen evolution efficiency and an oxygen evolution efficiency can be further improved, and a lifespan of the hydrogen evolution site and the oxygen evolution site can be sufficiently extended.

In the photocatalyst 1 according to the embodiment, the perovskite type crystal preferably contains strontium titanate. In this case, the co-catalyst may contain a rhodium-chromium mixed oxide, a rhodium-chromium composite oxide, or a cobalt oxide.

According to such a configuration, since a water splitting reaction quantum efficiency of strontium titanate is high, strontium titanate is preferably used as the base catalyst material of the photocatalyst 1. In addition, the rhodium-chromium mixed oxide and the rhodium-chromium composite oxide function as a hydrogen evolution co-catalyst, and the cobalt oxide functions as an oxygen evolution co-catalyst. Therefore, when these substances are contained as co-catalysts, a hydrogen evolution efficiency and an oxygen evolution efficiency can be improved, and the lifespan of the hydrogen evolution site and the oxygen evolution site can be extended.

The photocatalyst 1 according to the embodiment is preferably for use in the water splitting reaction.

According to such a configuration, it is possible to inexpensively produce hydrogen as renewable energy only by applying sunlight or the like.

Although the photocatalyst according to the disclosure is described above based on the shown embodiment, the disclosure is not limited thereto.

For example, the photocatalyst according to the disclosure may be obtained by adding any component to the embodiment.

### EXAMPLES

Next, specific examples of the disclosure will be described.

### 5. Production of Photocatalyst

### 5.1. Examples 1 to 3

First, particles of aluminum-doped strontium titanate (Al: SrTiO₃) were produced by a flux method. As a result of analysis by an X-ray diffraction method, it was confirmed that the obtained particles had a cubic perovskite type crystal.

Next, the obtained particles were used as a support, and a co-catalyst was loaded at the support by a photo-assisted electrodeposition method. Accordingly, photocatalysts of Examples 1 to 3 were obtained. In Examples 1 to 3, an occupancy ratio of a stepped structure was varied by changing production conditions of the support.

### 5.2. Comparative Example

A photocatalyst was produced in the same manner as in Example 1 except that the production conditions of the support were changed.

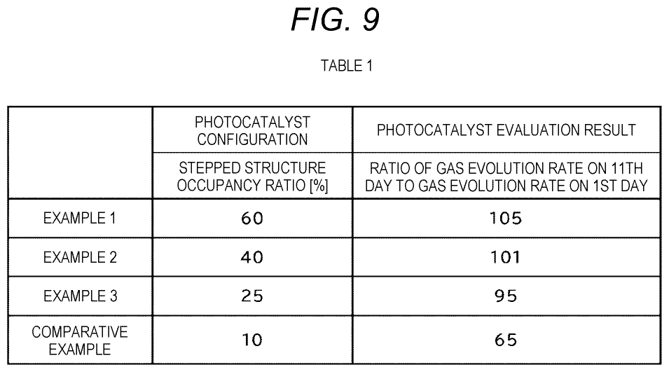

The production conditions of the photocatalyst are shown in Table 1 (FIG. 9). FIG. 9 is Table 1 showing the production conditions of the photocatalyst of each of Examples and Comparative Example and an evaluation result of the produced photocatalyst.

An average particle diameter of the photocatalyst produced in each of Examples and Comparative Example was 200 to 500 nm.

An average particle diameter of the co-catalyst was 0.2 to 10 nm.

On a surface of each photocatalyst, a {100} facet, a {110} facet, and a {111} facet were observed as flat surfaces. It was also observed that the stepped structure was distributed to surround the {100} facet.

A width of a terrace and a height of a step were each 1 nm to 15 nm, and a dihedral angle between the terrace and the step was 90°.

The number of repetitions of the terrace and the step was 5 to 20.

### 6. Evaluation of Support (Base Catalyst)

For the photocatalyst obtained in each of Examples and Comparative Example, the support before loading the co-catalyst was prepared. The support was tested to evaluate presence or absence of an electron separation site and a hole separation site. Hereinafter, a test method and a test result evaluation method will be described.

### 6.1. Test for Evaluating Presence or Absence of Electron Separation Site (Pt Loading Test)

An aqueous solution of hexachloroplatinate (IV) containing 0.1 g of each support, 30 mL of distilled water, and 0.0001 g of Pt was placed in a 50 mL screw vial and mixed to obtain a mixed solution. Next, the mixed solution was stirred and irradiated with light having a wavelength of 365 nm (ultraviolet light) for 10 minutes. Thereafter, the support was taken out from the mixed solution and dried to obtain a Pt-loaded support.

### 6.2. Test for Evaluating Presence or Absence of Hole Separation Site (CoOy Loading Test)

Specifically, a Co(NO₃)₂ aqueous solution containing 0.1 g of each support, 30 mL of distilled water, and 0.00005 g of Co was placed in a 50 mL screw vial and mixed to obtain a mixed solution. Next, the mixed solution was stirred and irradiated with light having a wavelength of 365 nm (ultraviolet light) for 10 minutes. Thereafter, the support was taken out from the mixed solution and dried to obtain a CoOy-loaded support.

### 6.3. Evaluation of Support, Pt-Loaded Support and CoOy-Loaded Support

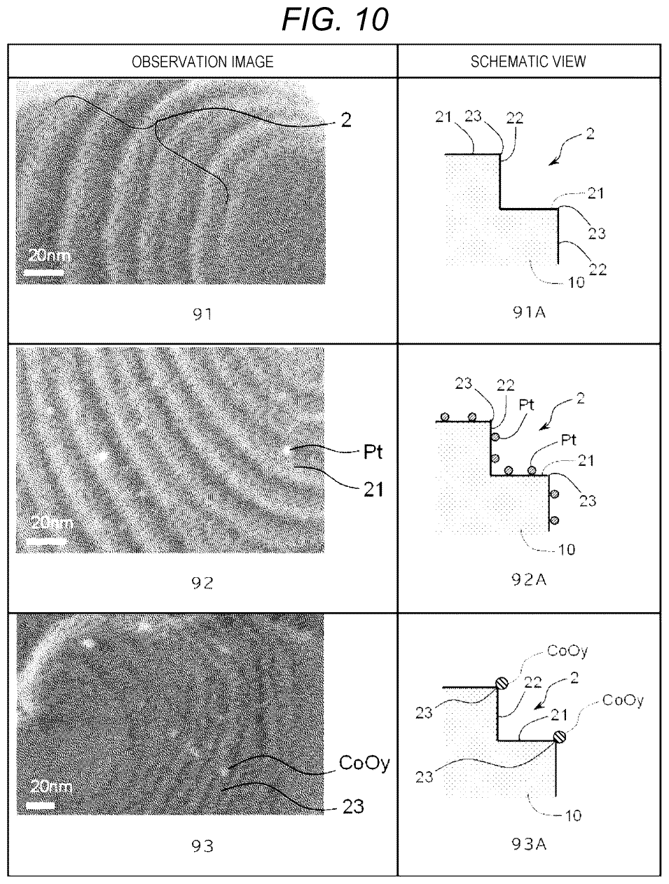

FIG. 10 shows, for the photocatalyst obtained in Example 1, an observation image 91 of the support 10 before loading the co-catalyst and a schematic view 91A thereof, an observation image 92 of the Pt-loaded support after the Pt loading test is performed on the support 10 shown in the observation image 91 and a schematic view 92A thereof, and an observation image 93 of the CoOy-loaded support after the CoOy loading test is performed on the support 10 shown in the observation image 91 and a schematic view 93A thereof.

In the observation image 91 in FIG. 10, it was confirmed that the stepped structure 2 was present at the support 10 of the photocatalyst obtained in Example 1. The schematic view 91A shows that the stepped structure 2 includes the terrace 21, the step 22, and the ridge portion 23.

In the observation image 92 in FIG. 10, it was confirmed that Pt particles were deposited at the terrace 21 and the step 22 in the stepped structure 2. The schematic view 92A schematically shows the deposited Pt particles. It is considered that the Pt particles deposited due to reduction of a precursor. Therefore, it was suggested that there is an electron separation site at the terrace 21 and the step 22 in the observation image 92.

In the observation image 93 in FIG. 10, it was confirmed that CoOy particles were deposited at the ridge portion 23 in the stepped structure 2. The schematic view 93A schematically shows the deposited CoOy particles. It is considered that the CoOy particles deposited due to oxidation of the precursor. Therefore, it was suggested that there is a hole separation site at the ridge portion 23 in the observation image 93.

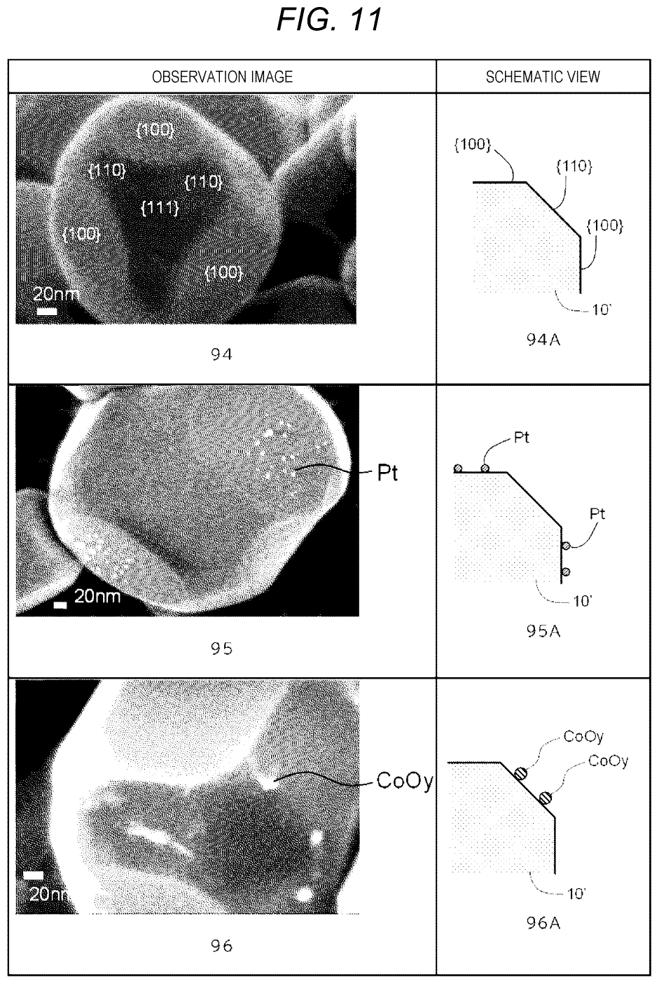

FIG. 11 shows, for the photocatalyst obtained in Comparative Example, an observation image 94 of a support 10′ before loading the co-catalyst and a schematic view 94A thereof, an observation image 95 of a Pt-loaded support after the Pt loading test is performed on the support 10′ shown in the observation image 94 and a schematic view 95A thereof, and an observation image 96 of a CoOy-loaded support after the CoOy loading test is performed on the support 10′ shown in the observation image 94 and a schematic view 96A thereof.

In the observation image 94 in FIG. 11, there are a large number of flat surfaces at the support 10′ of the photocatalyst obtained in Comparative Example, but there was almost no stepped structure. The schematic view 94A schematically shows a state in which there is no stepped structure.

In the observation image 95 in FIG. 11, it was observed that Pt particles were deposited at the flat surface. The schematic view 95A schematically shows the deposited Pt particles.

In the observation image 96 in FIG. 11, it was observed that CoOy particles were deposited at a flat surface different from the flat surface where the Pt particles were deposited. The schematic view 96A schematically shows the deposited CoOy particles.

### 7. Evaluation of Catalytic Activity of Photocatalyst

For the photocatalyst obtained in each of Examples and Comparative Example, water splitting reaction catalytic activity was evaluated by the following method.

First, 0.1 g of the photocatalyst was suspended in 50 mL of distilled water to prepare a suspension. Next, the obtained suspension was placed in a glass container and sealed. Next, the sealed glass container was irradiated with light having a wavelength of 365 nm using a 200 W high-pressure mercury lamp, and the suspension was stirred with a stirrer. Next, a gas evolved from the suspension was collected by a water displacement method via a tube coupled to the glass container. Then, a gas evolution rate each day was measured while continuing light irradiation for 11 days.

Next, the gas evolution rate measured on a 1st day was defined as 100, and a ratio of the gas evolution rate measured on an 11th day was calculated. Calculation results are shown in Table 1 (FIG. 9).

As shown in Table 1, in the photocatalyst obtained in each Example, the gas evolution rate on the 11th day was almost the same as the gas evolution rate on the 1st day. That is, high activity can be maintained for a long time. Meanwhile, in the photocatalyst obtained in Comparative Example, it has been found that the gas evolution rate on the 11th day was significantly lower than the gas evolution rate on the 1st day.

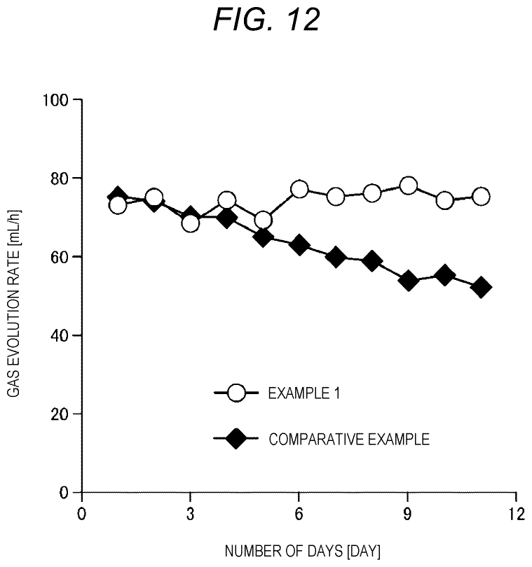

FIG. 12 is a graph comparing changes in the gas evolution rates over 11 days for the photocatalyst obtained in Example 1 and the photocatalyst obtained in Comparative Example. A horizontal axis in FIG. 12 represents a time (number of days), and a vertical axis in FIG. 12 represents a value obtained by converting a volume of the gas evolved in 24 hours into the volume of the gas evolved in one hour (gas evolution rate [mL/h]).

As shown in FIG. 12, in the photocatalyst obtained in Example 1, the gas evolution rate was substantially constant over 11 days. Meanwhile, in the photocatalyst obtained in Comparative Example, the gas evolution rate decreases as the time elapses.

From the above results, it was demonstrated that, according to the disclosure, it is possible to obtain a highly stable photocatalyst that can maintain high activity for a long time.

What is claimed is:

1. A photocatalyst comprising:
a perovskite type crystal, wherein
the photocatalyst has a stepped structure including a terrace and a step on a surface, and
an occupancy ratio of a projected area of the stepped structure to a total projected area of the surface is 20% or more.

2. The photocatalyst according to claim 1, wherein
the stepped structure is a structure in which the terrace and the step are alternately repeated a plurality of times.

3. The photocatalyst according to claim 1, wherein
the perovskite type crystal is a cubic crystal, and
the surface has a flat surface formed of a {100} facet.

4. The photocatalyst according to claim 3, wherein
the terrace is formed of the {100} facet, and
the step is formed of the {100} facet or a {110} facet.

5. The photocatalyst according to claim 4, wherein
a dihedral angle between the terrace and the step is 90° or more.

6. The photocatalyst according to claim 3, wherein
the stepped structure is distributed to surround the flat surface.

7. The photocatalyst according to claim 1, wherein
a width of the terrace is 3 nm or more and 25 nm or less.

8. The photocatalyst according to claim 1, wherein
the photocatalyst has a particulate form with an average particle diameter of 50 nm or more and 30,000 nm or less.

9. The photocatalyst according to claim 1, further comprising:
a co-catalyst in contact with the stepped structure.

10. The photocatalyst according to claim 9, wherein
the perovskite type crystal contains strontium titanate, and
the co-catalyst contains a rhodium-chromium mixed oxide, a rhodium-chromium composite oxide, or a cobalt oxide.

11. The photocatalyst according to claim 1, wherein
the photocatalyst is for use in a water splitting reaction.
